(19) United States
(12) Patent Application Publication
(10) Pub. No.: US 2024/0001600 A1
(43) Pub. Date: Jan. 4, 2024

(54) INJECTION MOLDING SYSTEM, AND CONTROL DEVICE

(71) Applicant: THE JAPAN STEEL WORKS, LTD., Shinagawa-ku, Tokyo (JP)

(72) Inventor: Kei IWATA, Tokyo (JP)

(73) Assignee: THE JAPAN STEEL WORKS, LTD., Shinagawa-ku, Tokyo (JP)

(21) Appl. No.: 18/209,309

(22) Filed: Jun. 13, 2023

(30) Foreign Application Priority Data
Jun. 30, 2022 (JP) 2022-105446

(51) Int. Cl. B29C 45/76

(52) U.S. Cl. CPC B29C 45/7666; B29C 2945/76521

(57) ABSTRACT

When acquiring a DR request for adjusting a use electric power amount from an electric power source, a control device executes an electric power control depending on the DR request.

### CROSS REFERENCE TO RELATED APPLICATIONS

This nonprovisional application is based on Japanese Patent Application No. 2022-105446 filed on Jun. 30, 2022 with the Japan Patent Office, the entire contents of which are hereby incorporated by reference.

### BACKGROUND OF THE INVENTION

### Field of the Invention

The present disclosure relates to an injection molding system, and a control device.

### Description of the Background Art

For example, Japanese Patent Laying-Open No. 2018-008397 discloses an injection molding system constituted by a plurality of injection molding machines and an electric power source that supplies electric power to the plurality of injection molding machines.

### SUMMARY OF THE INVENTION

In the above-described injection molding system, a so-called demand response request for adjusting a use electric power amount of the electric power source in the injection molding system is not considered.

The invention has been made for solving the problem, and provides an injection molding system and a control device that appropriately control the use electric power amount of the electric power source in the injection molding system when a demand response request is generated.

When acquiring a demand response request for adjusting a use electric power amount from an electric power source, an injection molding system and a control device according to an embodiment executes an electric power control depending on the demand response request.

The foregoing and other objects, features, aspects and advantages of the present invention will become more apparent from the following detailed description of the present invention that will be understood in conjunction with the accompanying drawings.

### BRIEF DESCRIPTION OF THE DRAWINGS

FIG. 1 is a diagram for describing a configuration example of an injection molding system in an embodiment;

FIG. 2 is a diagram for describing a configuration of an injection molding machine;

FIG. 3 is a diagram for describing an example of a priority database;

FIGS. 4(A)-4(D) are diagrams for describing various injection molding processes;

FIG. 5 is a functional block diagram of a control device;

FIG. 6 is a diagram for describing a battery; and

FIG. 7 is a flowchart showing a flow of a control by a control device.

### DESCRIPTION OF THE PREFERRED EMBODIMENT

An embodiment of the present invention will be described below in detail with reference to the drawings. Identical or equivalent portions in the figures are denoted by identical reference characters, and descriptions thereof are not repeated.

<Injection Molding System>

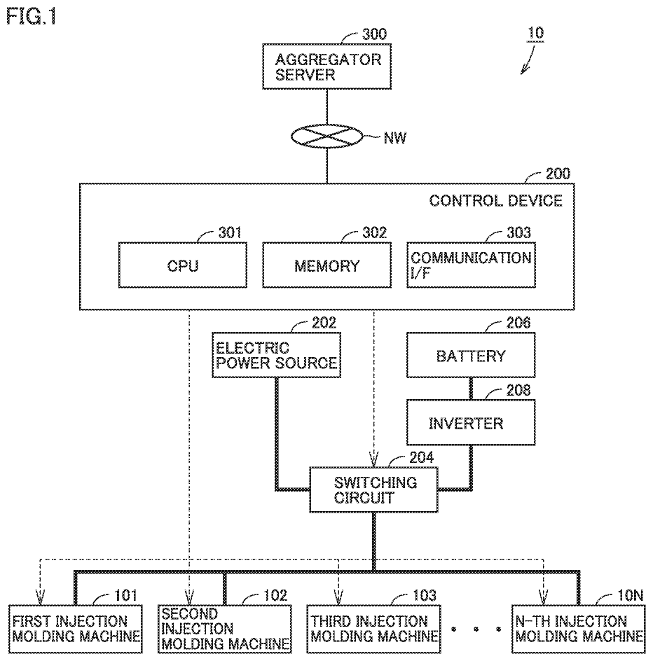

FIG. 1 is a diagram showing a configuration example of an injection molding system 10 in the embodiment. Injection molding system 10 includes N (N is an integer of 1 or more) injection molding machines 10n (n=1, . . . , N), a control device 200, an electric power source 202, a switching circuit 204, a battery 206, and an inverter 208. In the embodiment, N is an integer of 2 or more. In the example of FIG. 1, a first injection molding machine 101, a second injection molding machine 102, a third injection molding machine 103, . . . , a N-th injection molding machine ION are described as injection molding machine 10n.

Electric power source 202 supplies electric power source. For example, electric power source 202 is an external electric power source such as a commercial electric power source, and supplies alternating-current power.

Battery 206 performs charging and discharging. Direct-current power from battery 206 is output to inverter 208. Inverter 208 converts input direct-current power into alternating-current power, and converts input alternating-current power into direct-current power. Switching circuit 204 switches the output destination of electric power input to switching circuit 204.

Control device 200 performs the control of injection molding machines 10n and the control of switching circuit 204. For example, control device 200 can control switching circuit 204 such that the electric power from electric power source 202 is supplied to injection molding machines 10n. Further, control device 200 controls switching circuit 204 such that electric power from battery 206 is supplied to injection molding machines 10n. Injection molding machines 10n to which the electric power from electric power source 202 or battery 206 has been supplied execute an injection molding process using the electric power.

Further, control device 200 can control switching circuit 204 such that the electric power from electric power source 202 is supplied to battery 206. When the electric power from electric power source 202 is supplied to battery 206, battery 206 is charged.

Injection molding system 10 further includes an aggregator server 300 and a network NW. Control device 200 can communicate with aggregator server 300 through network NW.

Aggregator server 300 sends a demand response request to control device 200 through network NW. Hereinafter, the demand response request is also referred to as a “DR (Demand Response) request”. In the embodiment, the DR request is a request for adjusting a use electric power amount of electric power source 202 in injection molding system 10. In the DR request, for example, a prescribed electric power amount and a use period in which the prescribed electric power amount is used are prescribed. For example, the use period is prescribed by a start time and an end time.

Injection molding system 10 complies with the DR request, for example, by using electric power by the prescribed electric power amount prescribed in the DR request, in the use period prescribed in the DR request. Further, the DR request includes a DR increase request and a DR suppression request.

Typically, the DR increase request is a request that is generated when the electric power generation amount in an electric power facility or the like is excessively large. When control device 200 acquires the DR increase request, control device 200 increases the use electric power amount in injection molding system 10, compared to when the DR increase request is not acquired (normal time).

Typically, the DR suppression request is a request that is generated when the electric power generation amount in an electric power facility or the like is excessively small. When control device 200 acquires the DR suppression request, control device 200 decreases the use electric power amount in injection molding system 10, compared to when the DR suppression request is not acquired (normal time).

Control device 200 executes a control of the use electric power amount of electric power source 202 in injection molding system 10. The control is also referred to as an “electric power control”. Further, when acquiring DR request, control device 200 executes the electric power control depending on the DR request. In this configuration, control device 200 can control the use electric power amount of the electric power source in injection molding system 10, depending on the DR request for adjusting the use electric power amount.

Control device 200 includes a CPU (Central Processing Unit) 301, a memory 302, and a communication I/F (interface) 303. Memory 302 includes a ROM (Read Only Memory), a RAM (Random Access Memory), and the like. CPU 301 expands and executes a program stored in the ROM, on the RAM or the like. The program stored in the ROM is a program in which the control content of control device 200 is prescribed. The program may be distributed through a network. Further, a non-transitory recording medium in which the program is stored may be distributed. Further, various tables (maps) that are used for various computations are stored in the ROM.

<Configuration of Injection Molding Machine>

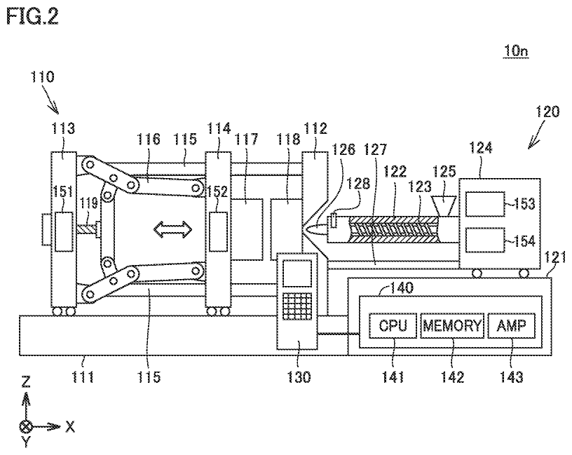

FIG. 2 is a diagram for describing a configuration of injection molding machine 10n. For explanatory convenience, in FIG. 2, an X-Y plane is defined as a floor surface on which injection molding machine 10n is disposed, and a Z-axis direction is defined as a direction perpendicular to the floor surface. A positive direction of a Z-axis is sometimes referred to as an upper surface side or an upward direction, and a negative direction is sometimes referred to as a lower surface side or a downward direction. Injection molding machine 10n is shown as a horizontal-type injection molding machine, but without being limited to the horizontal type, may be a vertical-type injection molding machine.

Injection molding machine 10n is configured to include a mold clamping device 110 for clamping molds, an injection device 120 for melting and injecting an injection material, a control panel 130, and a control device 140. In FIG. 2, mold clamping device 110 is disposed on the negative-directional side of an X-axis relative to injection device 120.

Mold clamping device 110 includes a bed 111, a fixed platen 112, a mold clamping housing 113, a movable platen 114, a tie bar 115, a mold clamping mechanism 116, molds 117, 118, and a ball screw 119. Bed 111 is disposed on the floor surface, and on the upper surface of bed 111, apparatuses such as fixed platen 112, mold clamping housing 113, and movable platen 114 are mounted.

On bed 111, fixed platen 112 is fixed at an edge portion on the side close to injection device 120 (that is, in the positive direction of the X-axis). Mold clamping housing 113 is disposed at an edge portion in the negative direction of the X-axis on bed 111. Fixed platen 112 and mold clamping housing 113 are coupled by tie bar 115 that includes a plurality of bars. Mold clamping housing 113 can move on bed 111 in the X-axis direction.

Movable platen 114 is disposed between fixed platen 112 and mold clamping housing 113 on bed 111. Movable platen 114 is configured to be capable of moving in the X-axis direction. Mold clamping housing 113 and movable platen 114 are coupled by mold clamping mechanism 116. Mold clamping mechanism 116 includes a toggle mechanism. The toggle mechanism, to which ball screw 119 is coupled, can move movable platen 114 in the X-axis direction relative to mold clamping housing 113, by driving a servomotor 151 disposed in mold clamping housing 113 and rotating ball screw 119. As mold clamping mechanism 116, a direct-acting cylinder that is driven by hydraulic pressure may be used.

Molds 117, 118 are disposed on movable platen 114 and fixed platen 112, respectively. Mold 117 and mold 118 are disposed so as to face each other between movable platen 114 and fixed platen 112. By moving mold 117 in the X-axis direction using mold clamping mechanism 116, it is possible to cause mold 117 to get contact with mold 118 tightly, or to cause mold 117 to separate from mold 118. In the following description, a step in which mold 117 and mold 118 transition from a separate state to a tight contact state is referred to as “mold clamping”. Further, a step in which mold 117 and mold 118 transition from the tight contact state to the separate state is referred to as “mold opening”.

In a mold clamping step, in a state where mold 117 tightly contacts with mold 118, a molten material (resin) is filled into the interior of the molds, and is cooled and solidified, so that a product having a desired shape can be molded. After the molding of the product, in the state where mold 117 has been separated from mold 118 by a mold opening step, a protrusion mechanism (not illustrated) disposed on movable platen 114 is operated, and thereby the molded product can be taken out of mold 117. The protrusion mechanism is driven by a servomotor 152 disposed on movable platen 114. A step in which the product is taken out using the protrusion mechanism is referred to as a “protrusion” step.

Injection device 120 includes a base 121, a heating cylinder 122, a drive device 124, a hopper 125, a nozzle touch device 127, and a temperature sensor 128. Base 121 is disposed on the floor surface on the positive-directional side of the X-axis relative to bed 111, and on the upper surface of base 121, drive device 124 is mounted. In drive device 124, servomotors 153, 154 are disposed.

Heating cylinder 122 extending in the X-axis direction is disposed on drive device 124. Heating cylinder 122 includes a heater (not illustrated) for heating the interior, a screw 123, and an injection nozzle 126. Screw 123 is driven by servomotor 153 in drive device 124, and is configured to be capable of rotating such that the rotation axis is the X-axis direction. Further, screw 123 is driven by servomotor 154, and is configured to be capable of moving in the X-axis direction. Injection nozzle 126 is disposed at an end portion of heating cylinder 122 on mold clamping device 110 side (that is, an end portion in the negative direction of the X-axis). Heating cylinder 122 produces the molten material by heating and melting resin material beads thrown in from hopper 125 and kneading it using screw 123. A step in which the resin material is molten in this way is referred to as a “plasticization” step.

Nozzle touch device 127 is constituted by a mechanism using a hydraulic cylinder or a mechanism using a ball screw, for example, and couples drive device 124 and fixed platen 112 of mold clamping device 110. In a case where nozzle touch device 127 is constituted by the mechanism using a ball screw, nozzle touch device 127 is driven by drive device 124, and moves drive device 124 and heating cylinder 122 in the X-axis direction. Nozzle touch device 127 causes injection nozzle 126 to get contact with a sprue bushing of mold 118 in mold clamping device 110, and injects the molten material from injection nozzle 126, so that the molten material is filled into a cavity of molds 117, 118. Servomotor 154 gives pressure to the molten material by moving screw 123 in heating cylinder 122 in the negative direction of the X-axis, puts the molten material into molds 117, 118, and keeps the pressure of the molten material after the putting-in constant.

The configuration of the nozzle touch mechanism is not limited to a configuration in which the whole of the injection device is moved by the ball screw disposed between fixed platen 112 and drive device 124 as described above, and may be another configuration. For example, a configuration in which a device frame and a fixed member at a heating cylinder rear portion are coupled using a ball screw and the heating cylinder itself is moved in a mold direction may be adopted. Alternatively, a configuration in which a slide base on which the injection device is mounted and the device frame are coupled using a ball screw and the injection nozzle is caused to get contact with the mold by moving the injection device together with the slide base may be adopted.

A step in which the molten material is put into molds 117, 118 is referred to as an “injection” step. Further, a step in which the molten material filled into molds 117, 118 is kept at a constant pressure and is cooled after the injection step is referred to as a “pressure keeping” step.

Temperature sensor 128 is disposed near injection nozzle 126 in heating cylinder 122. Temperature sensor 128 detects the temperature of the molten material in the interior of heating cylinder 122, and outputs the temperature to control device 140. Control device 140 controls the heater based on a detection value of temperature sensor 128, and adjusts the temperature of the molten material to a desired temperature.

When the pressure keeping step is completed, the mold opening step and the protrusion step are executed, and the molded product is taken out.

Injection molding machine 10n cyclically executes the mold clamping step, the injection step, the pressure keeping step, the plasticization step, the mold opening step, and the protrusion step repeatedly, and thereby can continuously form products. In the embodiment, the mold clamping step, the injection step, the pressure keeping step, the plasticization step, the mold opening step, and the protrusion step are collectively referred to as an “injection step for one cycle” also.

Control device 140 is stored in the interior of base 121. Control device 140 includes a CPU 141, a memory 142, and a servo amplifier 143 for driving servomotors 151 to 154. Control device 140 acquires detection values of various sensors disposed in injection molding machines 10n, and integrally controls injection molding machines 10n.

Control panel 130 is an apparatus through which an operator operates injection molding machine 10n, and includes a display device such as a liquid crystal display, and an input device such as a keyboard. Control panel 130, which is connected to control device 140, can acquire and display a state of injection molding machine 10n, and can output a user operation signal from an input device to control device 140. Control panel 130 may be a touch panel in which the display device and the input device are integrated. Further, control panel 130 may be attached to bed 111 or base 121 of injection molding machine 10n, or may be disposed at a position that is independent of injection molding machine 10n.

### Priority

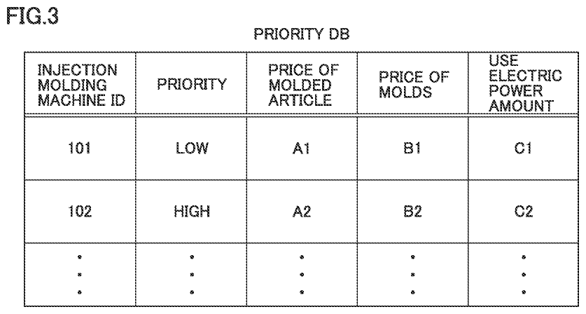

Next, the priority of injection molding machine 10n will be described. In the following description of the priority, FIG. 3 is mainly referred to, but FIGS. 1 and 2 are also referred to when necessary. In the embodiment, the priority is prescribed for each of injection molding machines 10n. The priority is used when control device 200 (refer to FIG. 1) acquires the DR request. FIG. 3 is an example of a priority DB (Data Base) in which the priority of injection molding machine 10n is prescribed. The priority DB is stored in control device 200.

In the example of the priority DB in FIG. 3, an injection molding machine ID (identification) is given to each of injection molding machines 10n. The injection molding machine ID is information for identifying each of injection molding machines 10n. In the example in FIG. 3, the reference characters (refer to FIG. 1) of injection molding machines 10n are used as the injection molding machine ID.

In the example in FIG. 3, a low priority is prescribed for first injection molding machine 101. Further, in the example in FIG. 3, a high priority is prescribed for second injection molding machine 102. In FIG. 3, “•••” shows that the injection molding machine IDs and priorities of the other injection molding machines are omitted.

In FIG. 3, “PRICE OF MOLDED ARTICLE” shows the price of a molded article that is generated by injection molding machine 10n. Further, “PRICE OF MOLDS” shows the price of molds 117, 118 that are included in injection molding machine 10n. Further, “USE ELECTRIC POWER AMOUNT” shows an electric power amount that injection molding machine 10n uses in an injection molding process for one cycle.

For example, the price of the molded article and the price of the molds are set by a user. Further, for example, the use electric power amount is decided by control device 200, based on the type of the molded article.

Control device 200 decides the priority of each of injection molding machines 10n, based on at least one of the price of the molded article, the price of the molds and the use electric power amount. In the embodiment, control device 200 decides the priority of each of injection molding machines 10n, by a predetermined algorithm, based on all of the price of the molded article, the price of the molds and the use electric power amount.

For example, in the case where control device 200 acquires the DR suppression request (in a case where the use electric power amount of injection molding machine 10n is decreased), it is preferable to preferentially drive an injection molding machine for which the price of the molded article to be produced is high. Accordingly, for the injection molding machine for which the price of the molded article is high, the priority is decided such that the priority is high. For example, when A1 is higher than A2 in the price of the molded article in FIG. 3 (that is, A1>A2), injection molding machine 101 has a higher priority than injection molding machine 102.

For example, in the case where control device 200 acquires the DR suppression request, it is preferable to preferentially drive an injection molding machine for which the price of molds 117, 118 is high, for recovering the cost of molds 117, 118. Accordingly, for the injection molding machine for which the price of molds 117, 118 is high, the priority is decided such that the priority is high. For example, when B1 is higher than B2 in the price of the molds in FIG. 3 (that is, B1>B2), injection molding machine 101 has a higher priority than injection molding machine 102.

For example, in the case where control device 200 acquires the DR suppression request, it is preferable to preferentially drive an injection molding machine for which the use electric power amount is small. Accordingly, for the injection molding machine for which the use electric power amount is small, the priority is decided such that the priority is high. For example, when C1 is smaller than C2 in the use electric power amount in FIG. 3 (that is, C1<C2), injection molding machine 101 has a higher priority than injection molding machine 102.

Further, the priority may be decided by the user, instead of being decided by control device 200. For example, control device 200 displays the price of the molded article, the price of the molds, and the use electric power amount for each of injection molding machines 10n, on the display device. The user decides the priority based on the displayed content.

[Various Injection Molding Process]

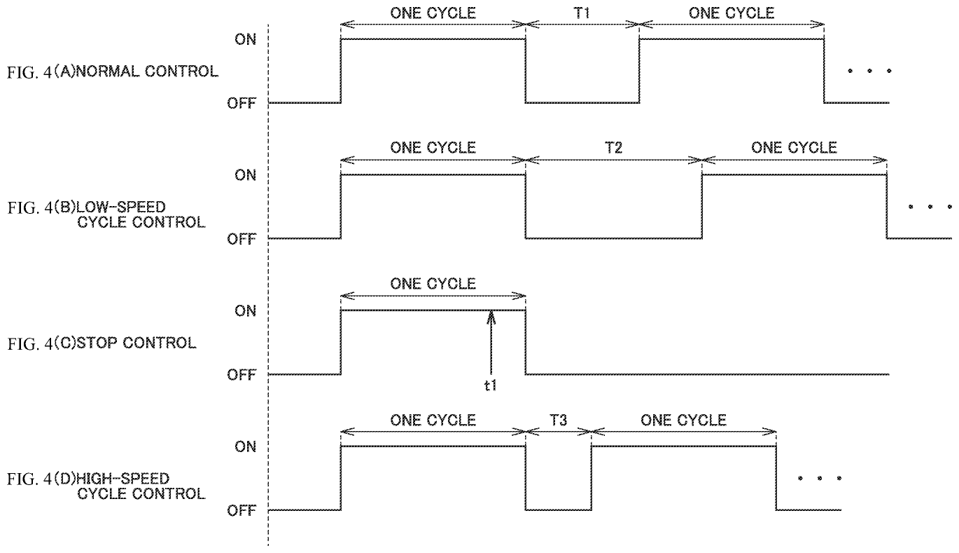

Injection molding machine 10n in the embodiment can execute various injection molding processes based on control by control device 200. FIGS. 4(A)-4(D) are diagrams for describing various injection molding processes. In the following description of various injection molding processes, FIGS. 4(A)-4(D) are mainly referred to, but FIGS. 1 and 2 are also referred to when necessary. In FIGS. 4(A) to 4(D), ON shows that the injection molding process is being executed, and OFF shows that the injection molding process is not being executed (that is, waiting). Further, hereinafter, a period from the end of the injection molding process for one cycle to the start of the injection molding process for the next cycle (that is, a period of OFF) is also referred to as a “wait period”.

FIG. 4(A) is a diagram showing a normal control. The normal control is a control that is executed when the DR request is not generated. In the example in FIG. 4(A), the wait period is T1.

FIG. 4(B) is a diagram showing a low-speed cycle control. The low-speed cycle control is a control that can be executed when control device 200 acquires the DR suppression request. In the example in FIG. 4(B), the wait period is T2. Here, T2>T1 is satisfied. In this way, in the low-speed cycle control, the wait period is longer than in the normal control. Accordingly, in the low-speed cycle control, the number of times of injection molding per unit time is smaller than in the normal control, but the use electric power amount per unit time can be reduced.

FIG. 4(C) is a diagram showing a stop control. The stop control is a control that can be executed when control device 200 acquires the DR suppression request. The stop control is a control to prohibit the execution of the injection molding process after the end of the injection molding process for one cycle when a later-described stop signal is received at a timing t1 during the control of the injection molding for the one cycle.

FIG. 4(D) is a diagram showing a high-speed cycle control. The high-speed cycle control is a control that can be executed when control device 200 acquires the DR increase request. In the example in FIG. 4(D), the wait period is T3. Here, T3<T1 is satisfied. In this way, in the high-speed cycle control, the wait period is shorter than in the normal control. Accordingly, in the high-speed cycle control, the use electric power amount per unit time is larger than in the normal control, but the number of times of injection molding per unit time can be increased.

In FIG. 4(B) and FIG. 4(D), control device 200 increases and decreases the use electric power amount per unit time by adjusting the length of the wait period relative to FIG. 4(A), but may increase and decrease the use electric power amount per unit time by adjusting the length of the period of one cycle. Further, the use electric power amount per unit time may be increased and decreased by adjusting both of the length of the wait period and the length of the period of one cycle. The length of the period of one cycle is adjusted in a range in which no problem arises about molding quality.

<Functional Block Diagram of Control Device 200>

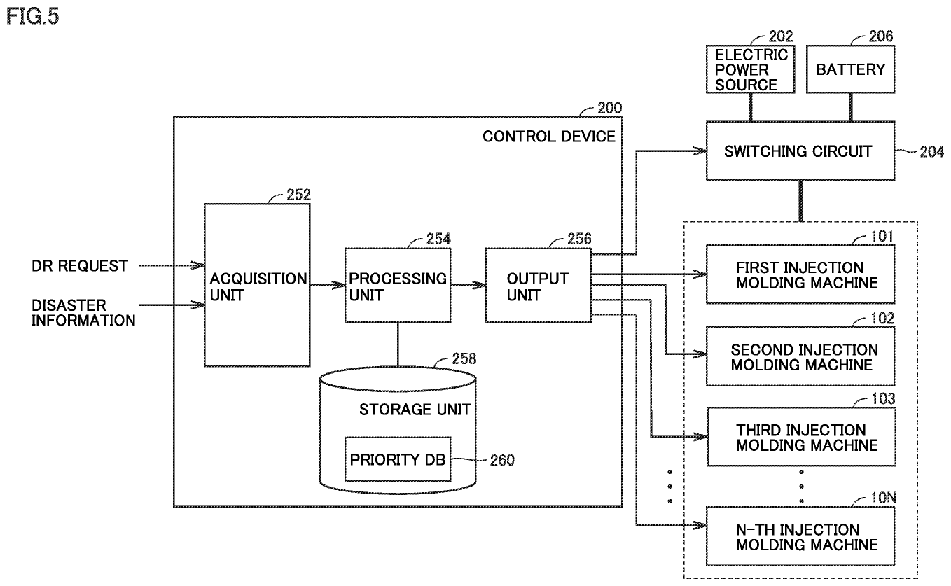

FIG. 5 is a functional block diagram of control device 200. Control device 200 includes an acquisition unit 252, a processing unit 254, an output unit 256, and a storage unit 258. Processing unit 254 corresponds to CPU 301 (refer to FIG. 1). Storage unit 258 corresponds to memory 302 (refer to FIG. 1). Acquisition unit 252 and output unit 256 correspond to communication I/F 303 (refer to FIG. 1). Processing unit 254 corresponds to a “controller” in the present disclosure.

Acquisition unit 252 acquires the DR request and later-described disaster information. The information acquired by acquisition unit 252 is output to processing unit 254. Processing unit 254 executes a process depending on the output information.

Further, the DR request includes type information indicating whether the DR request is the DR increase request or the DR suppression request. When acquiring the DR request, processing unit 254 refers to the type information, and determines whether the DR request is the DR increase request or the DR suppression request. In the case where the DR request is the DR suppression request, an electric power control to reduce the use electric power amount of electric power source 202 (refer to FIG. 1) in injection molding machine 10n is executed. The electric power control is also referred to as a “first electric power control”.

Further, processing unit 254 executes the first electric power control depending on the priority (refer to FIG. 3). Further, the first electric power control includes a restriction control to restrict the injection molding process by the injection molding machine (for example, first injection molding machine 101) having the low priority. In other words, control device 200 causes the injection molding machine having the low priority to execute the restriction control.

The restriction control includes at least one of the low-speed cycle control in FIG. 4(B) and the stop control in FIG. 4(C). In the embodiment, the restriction control includes both of the low-speed cycle control and the stop control. Further, the first electric power control includes a control to cause at least one injection molding machine of injection molding machines 10n to execute the normal control or the low-speed cycle control using the electric power of battery 206 (refer to FIG. 1). In the embodiment, the injection molding machine that uses the electric power of battery 206 is the injection molding machine (for example, second injection molding machine 102) having the high priority. In other words, control device 200 causes the injection molding machine having the high priority to execute the normal control by the electric power of battery 206.

Processing unit 254 decides the injection molding machine that executes the normal control, the injection molding machine that executes the low-speed cycle control, the injection molding machine that executes the stop control, and the injection molding machine that is driven by battery 206, based on the prescribed electric power amount and use period prescribed in the DR suppression request and a priority DB 260 (refer to FIG. 3 also) stored in storage unit 258. Processing unit 254 generates a command signal for causing injection molding machine 10n to execute the decided control. Then, processing unit 254 sends the command signal from output unit 256 to injection molding machine 10n. Further, in the case where there is the injection molding machine that is driven by battery 206, a command signal to switch switching circuit 204 such that the electric power from battery 206 (refer to FIG. 1) is supplied to the injection molding machine is generated. Then, processing unit 254 sends the command signal from output unit 256 to switching circuit 204.

As described above, when acquiring the DR suppression request, control device 200 executes the first electric power control to reduce the use electric power amount of injection molding machine 10n, and thereby can flexibly respond to the DR suppression request.

Further, the control device 200 executes the first electric power control depending on the priority. Accordingly, control device 200 can cause injection molding machine 10n to efficiently execute the injection molding process, while complying with the DR suppression request.

Further, control device 200 executes the restriction control to restrict the injection molding process by the injection molding machine having the low priority. Accordingly, control device 200 can restrain the decrease in the efficiency of the injection molding process by injection molding system 10, while complying with the DR suppression request.

Further, control device 200 executes the low-speed cycle control as the restriction control. Accordingly, without stopping the injection molding process for one cycle in the middle, control device 200 can reduce the use electric power amount of the injection molding machine having the low priority, and therewith can continue the injection molding process by the injection molding machine.

Further, control device 200 executes the stop control as the restriction control. Accordingly, without stopping the injection molding process for one cycle in the middle, control device 200 can considerably reduce the use electric power amount of the injection molding machine having the low priority. Further, in the stop control, a control to stop the injection molding process in the middle of one cycle is possible. However, in the case of stopping the injection molding process in the middle of one cycle, the problem of the breakage of components (for example, molds 117, 118) of the injection molding machine can arise. In contrast, by the execution of the stop control in the embodiment, the execution of the injection molding process is prohibited after the end of the injection molding process for one cycle, even when the injection molding machine receives the command signal indicating the stop control at the timing t1 (refer to FIG. 4(C)) in the middle of the injection molding machine for one cycle. Accordingly, it is possible to restrain the above problem from arising.

Further, as the first electric power control, control device 200 executes a control to drive the injection molding machine having the high priority using the electric power of battery 206. Accordingly, it is possible to reduce the use electric power amount of electric power source 202, and therewith to continue the injection molding process by the injection molding machine having the high priority. Further, in the embodiment, it is decided that the injection molding machine that uses the electric power of battery 206 is the injection molding machine having the high priority. Accordingly, it is possible to avoid control device 200 from performing the determination of whether the electric power from battery 206 is used by the injection molding machine having the high priority or by the injection molding machine having the low priority.

As a modification, control device 200 may use the electric power from battery 206 not only for the injection molding machine having the high priority but also for the injection molding machine having the low priority, based on the prescribed electric power amount in the DR suppression request and the SOC (State Of Charge) of battery 206. Accordingly, control device 200 can reduce the use electric power amount from electric power source 202, and therewith can drive at least one of the injection molding machine having the high priority and the injection molding machine having the low priority.

Further, the priority is prescribed by at least one of the unit price of the molded article of each of injection molding machines 10n, the price of molds 117, 118 (refer to FIG. 2) included in each of injection molding machines 10n, and the use electric power amount of each of injection molding machines 10n. Accordingly, injection molding system 10 can decide the priority from the standpoint of at least one of the unit price of the molded article, the price of the molds, and the use electric power amount.

What of the low-speed cycle control, the stop control, and the normal control with battery 206 is executed by the injection molding machine depending on the priority may be set by the user, or may be decided by control device 200.

Next, a case where the DR request acquired by acquisition unit 252 is the DR increase request will be described. In this case, processing unit 254 executes an electric power control to increase the use electric power amount of electric power source 202 of injection molding machine 10n. The electric power control is also referred to as a “second electric power control”.

The second electric power control includes the high-speed cycle control (refer to FIG. 4(D)). Further, the second electric power control includes the charging of battery 206. Processing unit 254 decides whether there are the injection molding machine that executes the high-speed cycle control and the charging of battery 206, based on the prescribed electric power amount and use period prescribed in the DR increase request and priority DB 260 stored in storage unit 258. For example, it is decided that the injection molding machine having the high priority is the injection molding machine that executes the high-speed cycle control.

Processing unit 254 generates a command signal for causing injection molding machine 10n to execute the decided control. Then, processing unit 254 sends the command signal from output unit 256 to injection molding machine 10n. Further, in the case where the decision of the charging of battery 206 is made, a command signal to switch switching circuit 204 is generated. This command signal is a signal for switching the switching circuit 204 such that at least some of the electric power from electric power source 202 is supplied to battery 206. Then, processing unit 254 sends the command signal from output unit 256 to switching circuit 204.

As described above, when acquiring the DR increase request, control device 200 executes the second electric power control to increase the use electric power amount of injection molding machine 10n, and thereby can flexibly respond to the DR increase request.

Further, control device 200 causes at least one injection molding machine (for example, the injection molding machine having the high priority) of injection molding machines 10n to execute the high-speed cycle control as the second electric power control. Accordingly, control device 200 can enhance the efficiency of the injection molding process, while complying with the DR increase request.

Further, control device 200 executes the charging of battery 206 as the second electric power control. Accordingly, control device 200 can charge battery 206, while complying with the DR increase request.

Next, a case where acquisition unit 252 acquires the disaster information will be described. The disaster information is information indicating that disaster (for example, typhoon or the like) has occurred. In the disaster information, the use electric power amount of electric power source 202 is prescribed. In the embodiment, when acquiring the disaster information during the execution of the electric power control depending on the DR request, control device 200 does not execute the control depending on the DR request (stops the control), and executes a control depending on the disaster information.

For example, in a case where the use electric power amount prescribed in the disaster information is zero (that is, in a case where the use of the electric power of electric power source 202 is prohibited), control device 200 adjusts the use electric power amount in injection molding system 10 to zero (that is, stops the drive of all injection molding machines 10n), regardless of the use electric power amount prescribed in the DR request. In this configuration, control device 200 can execute the control depending on the disaster information, which is more important than the DR request, in preference to the DR request.

[Battery]

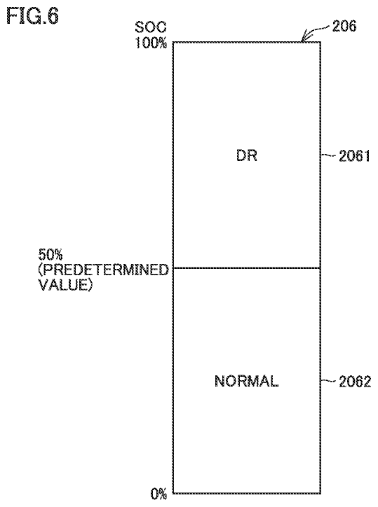

FIG. 6 is a diagram schematically showing battery 206 in the embodiment. Battery 206 in the embodiment is divided into a first capacity 2061 for DR and a second capacity 2062 for normal. First capacity 2061 is the capacity of the SOC of battery 206 that is more than a predetermined value. Further, second capacity 2062 is the capacity of the SOC of battery 206 that is the predetermined value or less. In the example in FIG. 6, the predetermined value is 50%.

The electric power accumulated in second capacity 2062 for normal is used in a predetermined step of the injection molding process for one cycle not at the time of the DR request but at the time of normal. For example, the predetermined step is a step in which a large amount of electric power is instantaneously used. Examples of the predetermined step include the mold clamping step, the injection step, and the mold opening step.

That is, in the case where the SOC of battery 206 is more than the predetermined value, the injection molding machine having the high priority is driven by the electric power of battery 206, at the time of the DR suppression request. Further, in the case where the SOC of battery 206 is the predetermined value or less, control device 200 drives injection molding machine 10n without using the electric power of battery 206, even at the time of the DR suppression request.

In this configuration, it is possible to secure electric power for normal in second capacity 2062, and therefore control device 200 can restrain the occurrence of a situation of “it is not possible to execute the above-described predetermined step during the response to the DR suppression because of electric power shortage”.

<Flow of Control by Control Device>

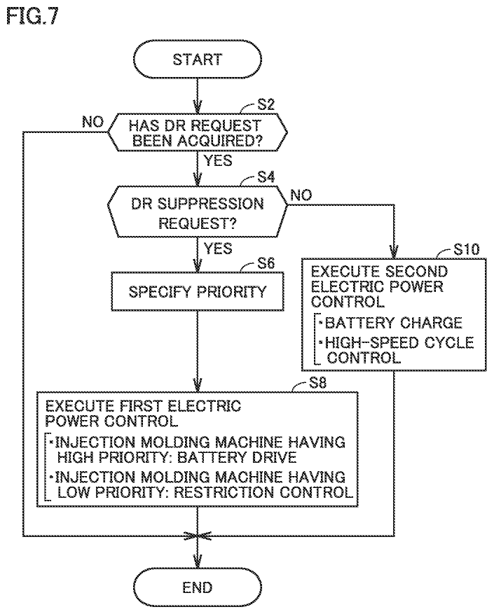

With reference to FIG. 7, a flow of the control by the control device will be described below. In the following description, FIG. 1 is also referred to when necessary. FIG. 7 is a flowchart showing the flow of the main control by control device 200 in the embodiment. Control device 200 executes the process in the flowchart at intervals of a constant period. In step S2, control device 200 determines whether the DR request has been acquired. In a case where control device 200 has not acquired the DR request (NO in step S2), the process ends.

Further, in a case where control device 200 has acquired the DR request (YES in step S2), the process proceeds to step S4. In step S4, control device 200 determines whether the DR request is the DR suppression request. In a case where the DR request is the DR suppression request (YES in step S4), the process proceeds to step S6. Further, in a case where the DR request is the DR increase request (NO in step S4), the process proceeds to step S10.

In step S6, control device 200 specifies the priority of each injection molding machine 10n by referring to priority DB 260 (refer to FIG. 3). Then, in step S8, control device 200 executes the first electric power control. Specifically, control device 200 decides controls for injection molding machines 10n, and sends command signals reflecting the decision, to injection molding machines 10n and switching circuit 204. For example, first injection molding machine 101 having the low priority is caused to execute the restriction control, and second injection molding machine 102 having the high priority is driven by battery 206.

In step S10, control device 200 executes the second electric power control. Specifically, control device 200 decides whether there is the charging of battery 206 and the injection molding machine that performs the high-speed cycle control, and sends command signals reflecting the decision, to injection molding machines 10n and switching circuit 204.

### Modification

(1) In the above-described FIG. 3, the configuration in which the priority is higher as the price of the molds is higher has been described. However, in the case where control device 200 acquires the DR suppression request, the electric power from electric power source 202 runs short. In this case, the injection molding process can be stopped in the middle of one cycle of the injection molding machine for which the price of molds 117, 118 is high, and molds 117, 118 can be broken. In view of this point, a configuration in which the priority is lower as the price of the molds is higher may be employed.

(2) Further, control device 200 may decide the process by a predetermined injection molding machine (the injection molding machine having the high priority or the injection molding machine having the low priority), based on the SOC of battery 206. For example, as ranges of the SOC, a first range, a second range larger than the first range, and a third range larger than the second range are set. A lower limit value of the third range corresponds to the “predetermined value” in the present disclosure. In a case where control device 200 acquires the DR suppression request and where the SOC is in the first range (that is, a remaining amount of battery 206 is a small amount), control device 200 causes an arbitrary injection molding machine (for example, the injection molding machine having the low priority) to execute the stop control. Further, in a case where the SOC belongs to the second range (that is, the remaining amount of battery 206 is a middle amount), control device 200 causes an arbitrary injection molding machine (for example, the injection molding machine having the low priority) to execute the restriction control using the electric power of battery 206. Further, in a case where the SOC belongs to the third range (that is, the remaining amount of battery 206 is a large amount), control device 200 causes an arbitrary injection molding machine (for example, the injection molding machine having the high priority) to execute the normal control using the electric power of battery 206. In this configuration, control device 200 can flexibly control injection molding machine 10n depending on the SOC. Further, the number of types of the range is not limited to three, and may be another value (for example, four or more).

(3) In the above-described embodiment, the configuration in which the number of types of the priority is two (the high priority and the low priority) has been described. However, the number of types of the priority may be three or more, and for example, a high priority, a middle priority, and a low priority are prescribed.

When acquiring the DR suppression request, control device 200 causes the injection molding machine having the high priority to execute the normal control with battery 206, causes the injection molding machine having the middle priority to execute the low-speed cycle control, and causes the injection molding machine having the low priority to execute the stop control. In this configuration, control device 200 allows the execution by injection molding machine 10n to be more flexible.

### Supplement

A person skilled in the art understands that a plurality of exemplary embodiments described above are specific examples of the following aspects.

(First Item) An injection molding system in the present disclosure includes at least one injection molding machine and a control device. The at least one injection molding machine executes an injection molding process using electric power from an electric power source. The control device executes an electric power control of a use electric power amount of the electric power source in the injection molding system. When acquiring a demand response request for adjusting the use electric power amount, the control device executes the electric power control depending on the demand response request.

(Second Item) In the injection molding system according to the first item, when the demand response request is a request for decreasing the use electric power amount, the control device executes a first electric power control to reduce the use electric power amount of the at least one injection molding machine, as the electric control.

(Third Item) In the injection molding system according to the second item, the at least one injection molding machine includes a first injection molding machine and a second injection molding machine, a priority about the injection molding process for the second injection molding machine being higher than for the first injection molding machine. The first electric power control includes a control depending on the priority.

(Forth Item) In the injection molding system according to the third item, the first electric power control includes a restriction control to restrict the injection molding process performed by the first injection molding machine.

(Fifth Item) In the injection molding system according to the fourth item, the restriction control includes a control to lengthen a period from end of the injection molding process for one cycle to start of the injection molding process for a next cycle, compared to when the restriction control is not being executed.

(Sixth Item) In the injection molding system according to the fourth or fifth item, the restriction control includes a control to prohibit execution of the injection molding process after end of the injection molding process for one cycle, when the use electric power amount of the first injection molding machine is decreased during the injection molding process for the one cycle.

(Seventh Item) In the injection molding system according to any one of the third to sixth items, the injection molding system further includes a battery. The first electric power control includes a control to drive at least one of the first injection molding machine and the second injection molding machine, using electric power of the battery.

(Eighth Item) In the injection molding system according to the seventh item, the first electric power control includes a control to drive the second injection molding machine, using the electric power of the battery.

(Ninth Item) In the injection molding system according to the third item, the injection molding system further includes a battery. The control device executes a control to drive at least one of the first injection molding machine and the second injection molding machine using electric power of the battery, as the first electric power control, when an SOC of the battery is more than a first predetermined value. Further, the control device executes a restriction control to restrict the injection molding process by the at least one of the first injection molding machine and the second injection molding machine, as the first electric power control, when the SOC of the battery is the predetermined value or less.

(Tenth Item) In the injection molding system according to any one of the third to ninth items, the priority is prescribed by at least one of a unit price of a molded article of each of the at least one injection molding machine, a price of a mold included in each of the at least one injection molding machine, and a use electric power amount of each of the at least one injection molding machine.

(Eleventh Item) In the injection molding system according to the first item, when the demand response request is a request for increasing the use electric power amount, the control device executes a second electric power control to increase the use electric power amount of the injection molding system, as the electric power control.

(Twelfth Item) In the injection molding system according to the eleventh item, the second electric power control includes a control to shorten a period from end of the injection molding process for one cycle to start of the injection molding process for a next cycle, compared to when the second electric power control is not being executed.

(Thirteenth Item) In the injection molding system according to the eleventh or twelfth item, the injection molding system further includes a battery. The second electric power control includes charging of the battery.

(Fourteen Item) In the injection molding system according to any one of the first to thirteenth items, when acquiring disaster information about disaster, the control device executes a control depending on the disaster information, without executing the electric power control.

(Fifteenth Item) A control device in the present disclosure includes an interface and a controller. The interface acquires a demand response request for adjusting a use electric power amount of an injection molding system including at least one injection molding machine that executes an injection molding process using electric power from an electric power source. The controller executes an electric power control of a use electric power amount of the electric power source in the injection molding system. The controller executes the electric power control depending on the demand response request.

As for the above-described embodiment and modifications, it is expected at the time of filing that configurations described in the embodiment are appropriately combined within a range where disadvantage or inconsistency is not produced, including combinations that are not mentioned in the specification.

Although the embodiment of the present invention has been described, it should be understood that the embodiment disclosed herein are examples and are not to be taken by way of limitation in all respects. It is intended that the scope of the present invention is interpreted by the claims and includes all modifications within a meaning and range equivalent to the claims.

1. An injection molding system comprising:
at least one injection molding machine that executes an injection molding process using electric power from an electric power source; and
a control device that executes an electric power control of a use electric power amount of the electric power source in the injection molding system, wherein
when acquiring a demand response request for adjusting the use electric power amount, the control device executes the electric power control depending on the demand response request.

2. The injection molding system according to claim 1, wherein when the demand response request is a request for decreasing the use electric power amount, the control device executes a first electric power control to reduce the use electric power amount of the at least one injection molding machine, as the electric control.

3. The injection molding system according to claim 2, wherein:
the at least one injection molding machine includes a first injection molding machine and a second injection molding machine, a priority about the injection molding process for the second injection molding machine being higher than for the first injection molding machine; and
the first electric power control includes a control depending on the priority.

4. The injection molding system according to claim 3, wherein the first electric power control includes a restriction control to restrict the injection molding process performed by the first injection molding machine.

5. The injection molding system according to claim 4, wherein the restriction control includes a control to lengthen a period from end of the injection molding process for one cycle to start of the injection molding process for a next cycle, compared to when the restriction control is not being executed.

6. The injection molding system according to claim 4, wherein the restriction control includes a control to prohibit execution of the injection molding process after end of the injection molding process for one cycle, when the use electric power amount of the first injection molding machine is decreased during the injection molding process for the one cycle.

7. The injection molding system according to claim 3, further comprising a battery, wherein
the first electric power control includes a control to drive at least one of the first injection molding machine and the second injection molding machine, using electric power of the battery.

8. The injection molding system according to claim 7, wherein the first electric power control includes a control to drive the second injection molding machine, using the electric power of the battery.

9. The injection molding system according to claim 3, further comprising a battery, wherein
the control device
executes a control to drive at least one of the first injection molding machine and the second injection molding machine using electric power of the battery, as the first electric power control, when an SOC (State Of Charge) of the battery is more than a first predetermined value, and
drives the at least one injection molding machine without using the electric power of the battery, when the SOC of the battery is the first predetermined value or less.

10. The injection molding system according to claim 3, wherein the priority is prescribed by at least one of a unit price of a molded article of each of the at least one injection molding machine, a price of a mold included in each of the at least one injection molding machine, and a use electric power amount of each of the at least one injection molding machine.

11. The injection molding system according to claim 1, wherein when the demand response request is a request for increasing the use electric power amount, the control device executes a second electric power control to increase the use electric power amount of the injection molding system, as the electric power control.

12. The injection molding system according to claim 11, wherein the second electric power control includes a control to shorten a period from end of the injection molding process for one cycle to start of the injection molding process for a next cycle, compared to when the second electric power control is not being executed.

13. The injection molding system according to claim 11, further comprising a battery, wherein
the second electric power control includes charging of the battery.

14. The injection molding system according to claim 1, wherein when acquiring disaster information about disaster, the control device executes a control depending on the disaster information, without executing the electric power control.

15. A control device comprising:
an interface that acquires a demand response request for adjusting a use electric power amount of an injection molding system including at least one injection molding machine that executes an injection molding process using electric power from an electric power source; and
a controller that executes an electric power control of a use electric power amount of the electric power source in the injection molding system, wherein
the controller executes the electric power control depending on the demand response request.
